(19) United States
(12) Patent Application Publication
(10) Pub. No.: US 2015/0231034 A1
(43) Pub. Date: Aug. 20, 2015

(54) TELESCOPIC FEMALE DRUG VIAL ADAPTER

(71) Applicant: MEDIMOP Medical Projects Ltd., Ra'anana (IL)

(72) Inventors: Nimrod Lev, Savion (IL); Igor Denenburg, Gedera (IL); Mordechai Bukhman, Netanya (IL)

(73) Assignee: MEDIMOP MEDICAL PROJECTS LTD., Ra'anana (IL)

(21) Appl. No.: 14/425,482

(22) PCT Filed: Oct. 17, 2012
(86) PCT No.: PCT/IL2012/050407

§ 371 Date: Mar. 3, 2015

(30) Foreign Application Priority Data
Sep. 13, 2012 (IL) 221920

(51) Int. Cl. A61J 1/20

(52) U.S. Cl. CPC A61J 1/2055; A61J 1/2051; A61J 1/2082; A61J 1/2075

(57) ABSTRACT

A telescopic female drug vial adapter including a spike component telescopically mounted on a skirt component for snap fit on and puncturing a drug vial in an actuated position. The telescopic female drug vial adapter is particularly suitable for implementation in a vented version to avoid wetting of its air filter during aspiration of liquid contents from a drug vial.

### FIELD OF THE INVENTION

The invention relates to drug vial adapters in general and female drug vial adapters in particular.

### BACKGROUND OF THE INVENTION

Commonly owned PCT International Application No. PCT/IL2006/000912 entitled Liquid Drug Transfer Devices for Failsafe Correct Snap Fitting onto Medicinal Vials and published under PCT International Publication No. WO 2007/017868 illustrates and describes liquid drug transfer devices including a drug vial adapter designed for guided alignment with a drug vial prior to snap fitting thereon and puncturing same for ensuring flow communication with the drug vial's interior. WO 2007/017868 FIG. 4 illustrates a vented female drug vial adapter for use with a needleless syringe.

A WO 2007/017868 drug vial adapter includes a top wall with a downward depending puncturing member and an opposite upright access port in flow communication with the puncturing member. The top wall is also formed with a downward depending generally cylindrical skirt surrounding the puncturing member. The generally cylindrical skirt includes at least four axially directed flex members longer than the puncturing member to avoid the puncturing member contacting a drug vial's drug vial stopper prior to alignment of the drug vial adapter and the drug vial. The axially directed flex members include two non-adjacent drug vial retention flex members for snap fitting over a drug vial opening for drug vial retention purposes and at least two non-adjacent drug vial guidance flex members longer than their counterpart drug vial retention flex members for guiding the drug vial adapter with respect to a drug vial prior to snap fitting thereon.

A WO 2007/017868 vented female drug vial adapter includes a dual lumen puncturing member having a liquid transfer lumen and a venting lumen. The liquid transfer lumen is in flow communication with a female connector for sealingly receiving a needleless syringe. The venting lumen is in flow communication with a generally circular air filter formed in the top wall. Inversion of the vented female drug vial adapter for aspiration of its liquid drug contents leads to liquid drug contents undesirably entering the venting lumen and wetting the air filter therefore considerably detracting from its ability to enable filtered air to pass therethrough for pressure equalization purposes during aspiration.

There is a need for female drug vial adapters for guided alignment relative to a drug vial prior to mounting thereon and puncturing but with a longer puncturing member.

### SUMMARY OF THE INVENTION

The present invention is directed toward female drug vial adapters including a dual component construction having a spike component telescopically mounted on a skirt component for manual displacement from a set-up position to an actuated position for snug mounting on and puncturing a drug vial. Manual displacement of the spike component towards the skirt component affords initial guided alignment of the drug vial adapter relative to a drug vial prior to being snugly mounted thereon and puncturing same.

The present invention is particularly advantageous for vented female drug vial adapters which can be provisioned with a long puncturing member having a venting lumen with a venting lumen aperture at its puncturing tip. The vented female drug vial adapters are intended to be used with needleless syringes filled with a predetermined volume of liquid contents such that, on inversion of a vented female drug vial adapter mounted on a drug vial with liquid drug contents for aspiration purposes, the venting lumen aperture is above the liquid level of the liquid drug contents in a manner resembling a swimming snorkel. By virtue of this arrangement, liquid drug contents are precluded from entering the venting lumen and wetting the air filter.

### BRIEF DESCRIPTION OF DRAWINGS

In order to understand the invention and to see how it can be carried out in practice, a preferred embodiment will now be described, by way of a non-limiting example only, with reference to the accompanying drawings in which similar parts are likewise numbered, and in which:

FIG. 1 is a pictorial representation of a syringe, a drug vial including a longitudinal cross section, and a vented telescopic female drug vial adapter having a longitudinal drug vial adapter axis in a set-up position;

FIG. 2 is an exploded view of the vented telescopic female drug vial adapter;

FIG. 3 is a top plan view of the vented telescopic female drug vial adapter along the longitudinal drug vial adapter axis;

FIG. 4 is a longitudinal cross section of the vented telescopic female drug vial adapter along line A-A in FIG. 3 in a set-up position;

FIG. 5 is a longitudinal cross section of the vented telescopic female drug vial adapter along line B-B in FIG. 3 in its set-up position;

FIG. 6 is a longitudinal cross section of the vented telescopic female drug vial adapter along line A-A in FIG. 3 in an actuated position;

FIG. 7 is a longitudinal cross section of the vented telescopic female drug vial adapter along line B-B in FIG. 3 in its actuated position;

FIG. 8A is a longitudinal cross section of the vented telescopic female drug vial adapter and the drug vial along line A-A in FIG. 3 prior to use;

FIG. 8B is a longitudinal cross section of the vented telescopic female drug vial adapter and the drug vial along line A-A in FIG. 3 pursuant to an initial downward depression of the former toward the latter;

FIG. 8C is a longitudinal cross section of the vented telescopic female drug vial adapter and the drug vial along line A-A in FIG. 3 pursuant to continuing downward depression of the former toward the latter;

FIG. 8D is a longitudinal cross section of the vented telescopic female drug vial adapter fully mounted on and puncturing the drug vial along line A-A in FIG. 3;

FIG. 8E is a longitudinal cross section of the vented telescopic female drug vial adapter fully mounted on and puncturing the drug vial along line B-B in FIG. 3;

FIG. 8F is a longitudinal cross section of the vented telescopic female drug vial adapter and the drug vial along line A-A in FIG. 3 on screw threading a needleless syringe on the former for injection purposes; and

FIG. 8G is a longitudinal cross section of the vented telescopic female drug vial adapter and the drug vial along line A-A in FIG. 3 after inversion for aspiration purposes.

### DETAILED DESCRIPTION OF PREFERRED EMBODIMENT OF THE INVENTION

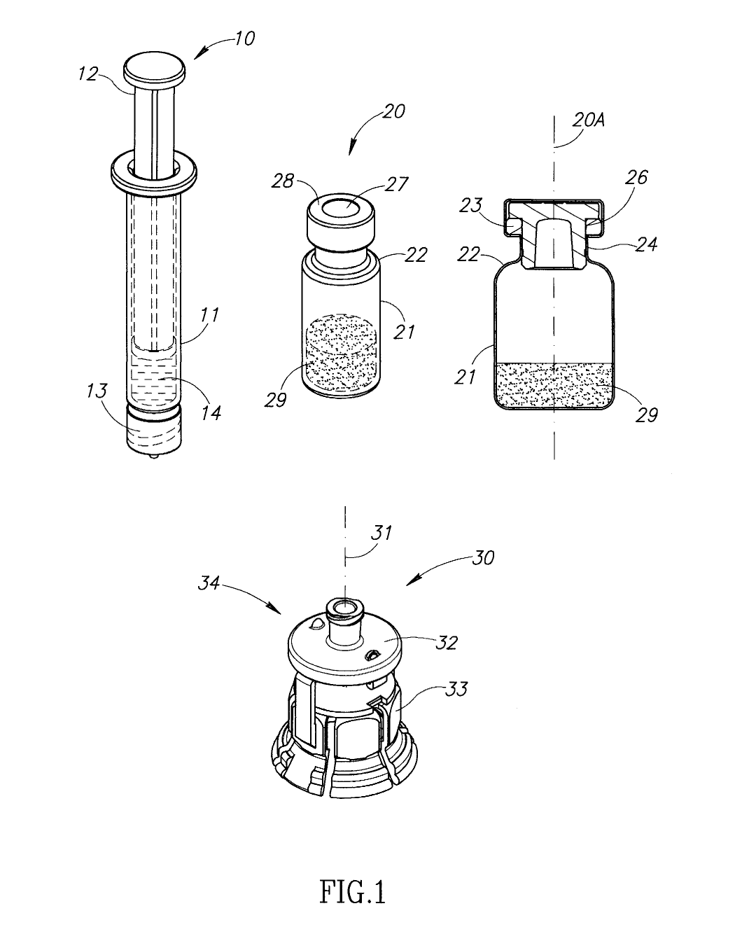

FIG. 1 shows a syringe 10 constituting a source of physiological fluid, a medicinal drug vial 20 and a vented telescopic female drug vial adapter 30 for use with the syringe 10 and the drug vial 20. The syringe 10 includes a barrel 11 with a plunger 12 and a male Luer lock connector 13. The syringe 10 can be formed with other types of male connectors. The syringe 10 is filled with a liquid component 14. The liquid component 14 can be diluent only. Alternatively, the liquid component 14 can include an active component.

The drug vial 20 has a longitudinal drug vial axis 20A and includes a drug vial bottle 21 having a drug vial shoulder 22, a drug vial rim 23 and an intermediate narrow drug vial neck 24. The drug vial rim 23 defines a drug vial opening 26 sealed by a drug vial stopper 27 capped by a band 28. The drug vial 20 contains a powder drug 29 under negative pressure or a liquid drug 29.

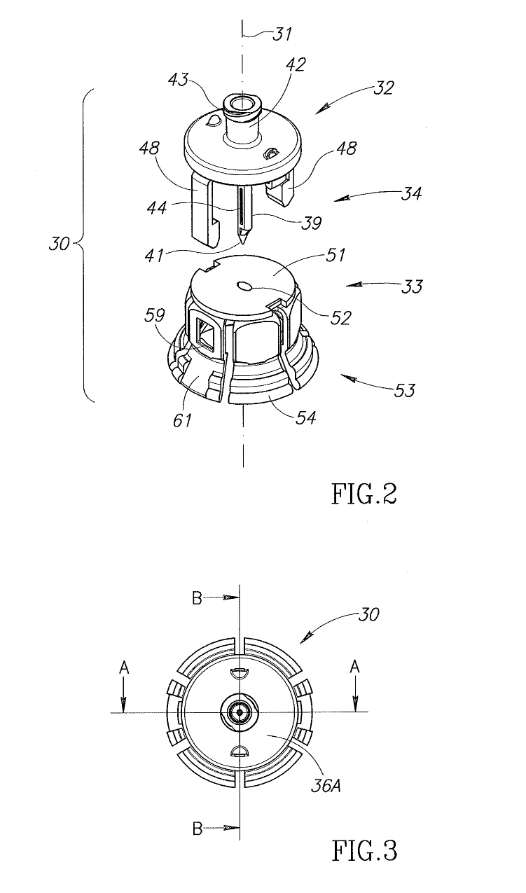

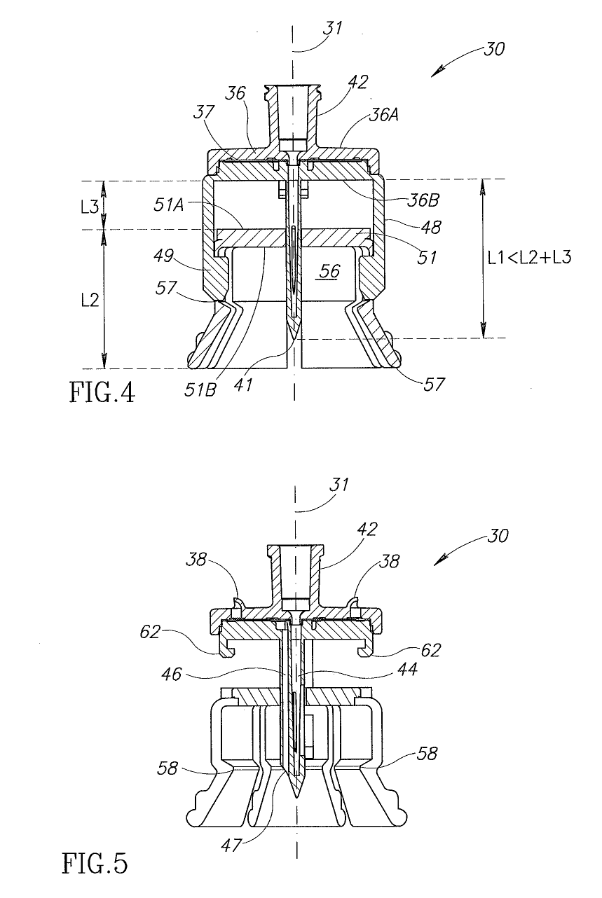

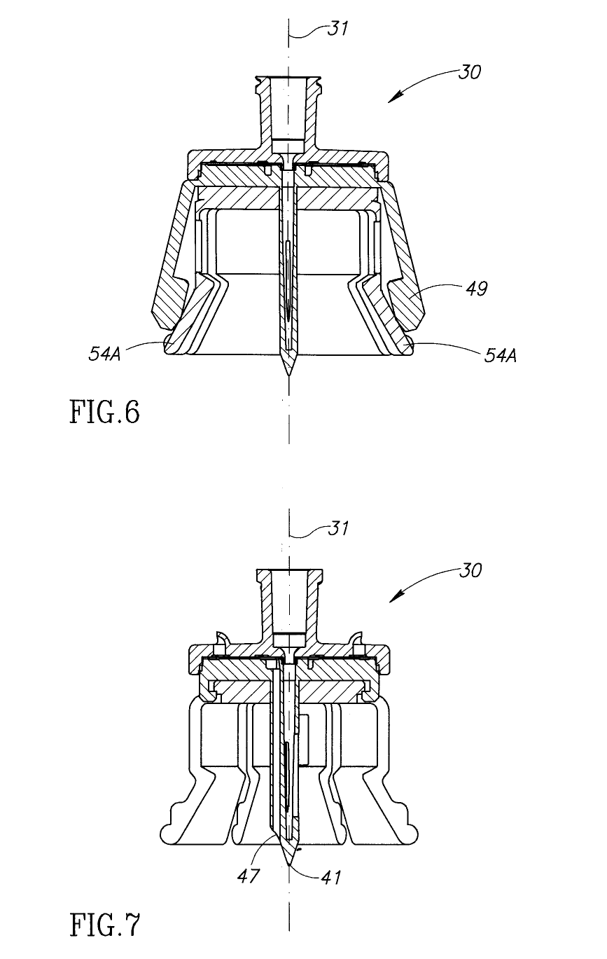

FIGS. 1 to 7 show the vented telescopic female drug vial adapter 30 has a longitudinal drug vial adapter axis 31 and includes a vented spike component 32, a skirt component 33 and a securing arrangement 34 for securing the spike component 32 on the skirt component 33 in an actuated position as shown in FIGS. 6 and 7.

The vented spike component 32 includes a transversely directed spike component top wall 36 having a circular air filter 37 and a pair of vent apertures 38. The vented spike component 32 preferably includes protective hoods 38 as illustrated and described in commonly owned PCT International Application No. PCT/2011/000187 entitled Liquid Drug Transfer Device with Vented Vial Adapter and published under PCT International Publication No. WO 2011/104712.

The spike component top wall 36 includes a downward depending dual lumen puncturing member 39 with a puncturing tip 41 for puncturing a drug vial stopper and an opposite upright female connector 42. The female connector 42 is preferably a female Luer connector with an external screw thread 43. The dual lumen puncturing member 39 includes a liquid transfer lumen 44 in flow communication with the opposite upright female connector 42. The dual lumen puncturing member 39 includes a venting lumen 46 having a venting lumen aperture 47 adjacent the puncturing tip 41 and in flow communication with the pair of vent apertures 38.

The spike component top wall 36 includes an uppermost spike component top wall surface 36A facing the upright female connector 42 and a lowermost spike component top wall surface 36B facing the dual lumen puncturing member 39. The puncturing member 39 has a length L1 defined between the lowermost spike component top wall surface 36B and the puncturing tip 41.

The spike component top wall 36 also includes a pair of opposite spaced apart downward depending spike component legs 48 lateral to the puncturing member 39. The spike component legs 48 terminate at leg tips 49 inwardly protruding toward the puncturing tip 41.

The skirt component 33 includes a transversely directed skirt component top wall 51 having a central aperture 52 and a downward depending substantially cylindrical skirt 53. The skirt 53 includes a multitude of drug vial flex members 54 defining a drug vial rim cavity 56 for snugly receiving the drug vial rim 23 therein and a skirt component margin 57 remote from the skirt component top wall 51. The drug vial flex members 54 preferably include inward directed projections 58 for snap fitting on the drug vial rim 23.

The skirt component top wall 51 includes an uppermost skirt component top wall surface 51A facing the spike component 32 and a lowermost skirt component top wall surface 51B facing the skirt 53. The skirt 53 has a length L2 defined between the uppermost skirt component top wall surface 51A and the skirt component margin 57.

Two opposite drug vial flex members 54A have leg tip apertures 59 for initially receiving the leg tips 49 for initially spacing the spike component top wall 36 from the skirt component top wall 51 with the puncturing member 39 protruding through the central aperture 52 in a set-up position of the telescopic female drug vial adapter 30. The drug vial flex members 54A are preferably formed with smooth outside surfaces 61 beneath the leg tip apertures 59 to enable smooth sliding movement of the legs tips 49 towards the skirt component margin 57.

In the set-up position, the lowermost spike component top wall surface 36B and the uppermost skirt component top wall surface 51A are separated by a length L3. In the set-up position, L1<L2+L3 such that the puncturing tip 41 does not protrude beyond the skirt component margin 57 which would lead to the puncturing tip 41 contacting a drug vial stopper 27 prior to correct alignment of the vented telescopic female drug vial adapter 30 with a drug vial 20. The puncturing member 39 and the skirt 53 are preferably dimensioned such that L1>L2 such that the venting tip aperture 47 protrudes beyond the skirt component margin 57 in the actuated position in which the spike component 32 fully abuts the skirt component 33.

The securing arrangement 34 includes a pair of opposite snap fit clips 62 orthogonal to the pair of opposite spike component legs 48.

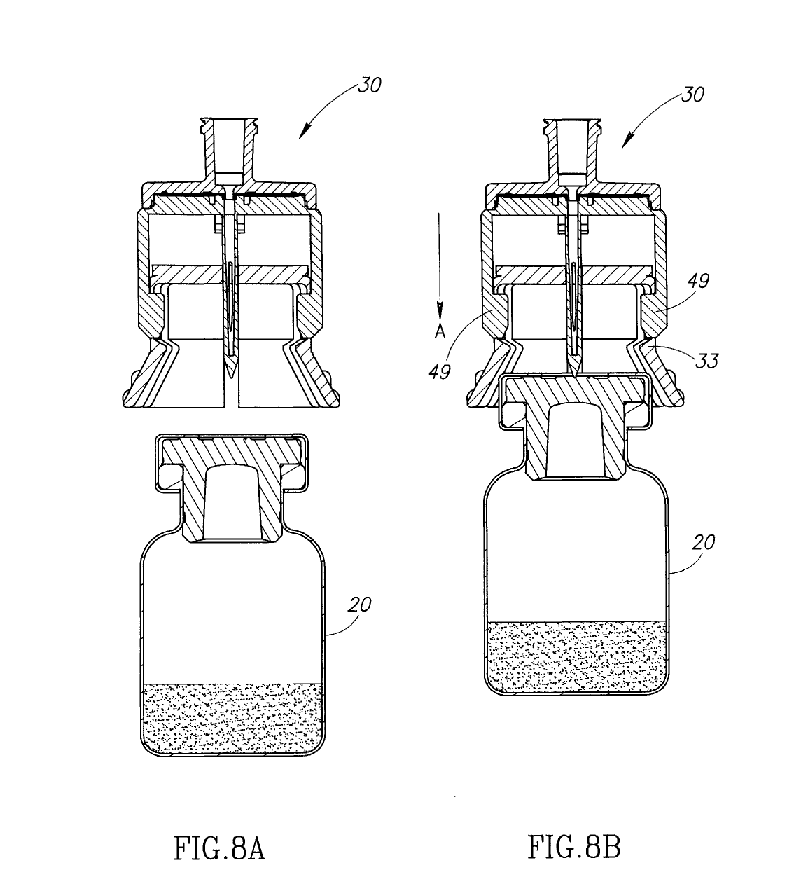

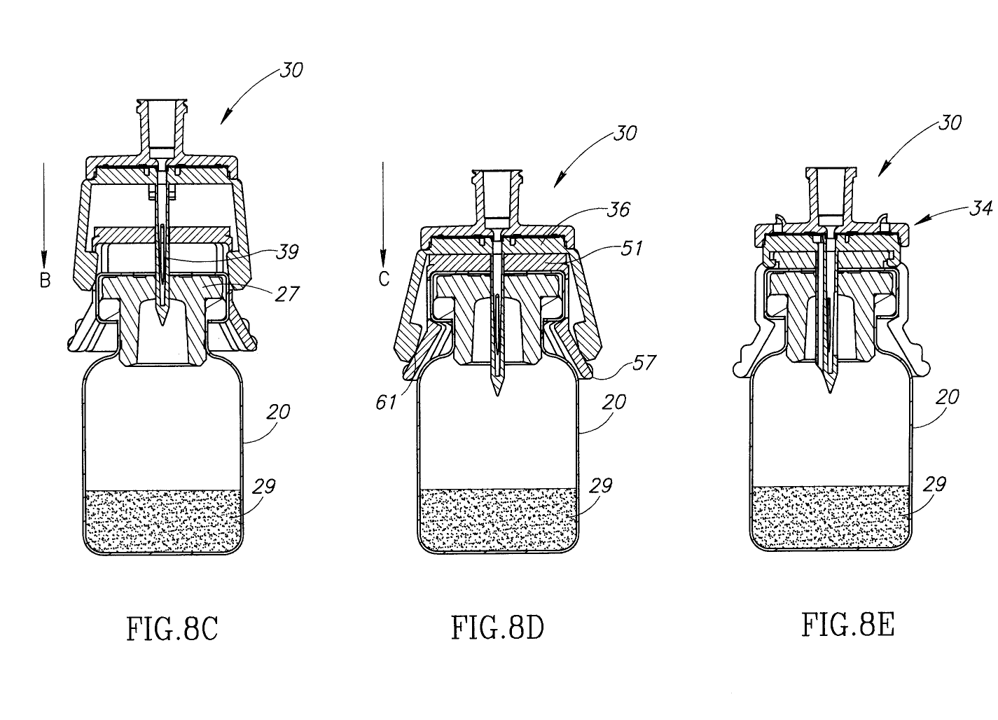

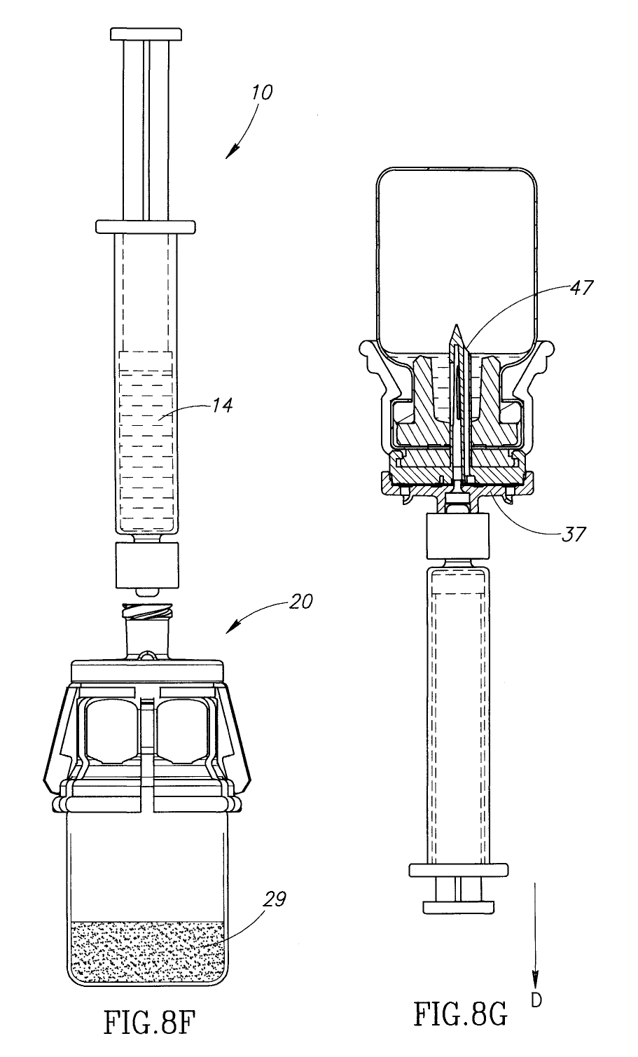

FIGS. 8A to 8G show the use of the needleless syringe 10, the drug vial 20 and the vented telescopic female drug vial adapter 30. The needleless syringe 10 is filled with a pre-determined volume of liquid contents 29 to ensure a snorkel like effect such that liquid contents do not wet the circular air filter 37 as described hereinbelow with respect to FIG. 8G.

FIG. 8A shows the female drug vial adapter 30 in its set-up position and in co-axial alignment with the drug vial 20 ready for snap fitting thereon and puncturing same.

FIG. 8B shows an initial downward depression of the female drug vial adapter 30 toward the drug vial 20 as denoted by arrow A. The leg tips 49 impart a downward force to the skirt component 33. The flex members 54 ensure the spike component 32 is aligned with the skirt component 33 in case of misalignment before the puncturing tip 41 starts puncturing the drug vial stopper 27.

FIG. 8C shows continuing downward depression of the drug vial adapter 30 towards the drug vial 20 as denoted by arrow B causes the puncturing member 39 to puncture the drug vial stopper 27. The drug vial 20 urges the leg tips 49 radial outward from the leg tip apertures 59. In the case of negative pressure drug vial 20, air enters the drug vial 20 via both the liquid transfer lumen 44 and the venting lumen 46.

FIGS. 8D and 8E show complete downward depression of the drug vial adapter 30 towards the drug vial 20 until the former 30 snap fits on and punctures the drug vial stopper 27 as denoted by arrow C. The spike component 32 stops against the skirt component 33. The leg tips 49 slide along the smooth external surfaces 61 towards the skirt component margin 57. The securing arrangement 34 is engaged to secure the drug vial adapter 30 and the drug vial 20.

FIG. 8F shows the syringe 10 ready for screw thread mounting on the female drug vial adapter 30 for injection of its liquid contents 29. The assemblage of the syringe 10, the drug vial 20 and the female drug vial adapter 30 is gently agitated to ensure complete reconstitution of powder contents. On injection of the liquid contents, air exits from the drug vial 20 via the venting lumen 46 and the vent apertures 38.

FIG. 8G shows inversion of FIG. 8F's assemblage for aspiration of the liquid drug contents from the drug vial 20 to the syringe 10 as denoted by arrow D for administration purposes. The venting lumen aperture 47 is above the liquid level of the drug liquid contents to resemble a swimming snorkel such that the air filter 37 is not wetted. Air is drawn into the drug vial 20 via the vent apertures 38, the air filter 37 and the venting lumen 46.

While the invention has been described with respect to a limited number of embodiments, it will be appreciated that many variations, modifications, and other applications of the invention can be made within the scope of the appended claims.

1.-5. (canceled)

6. A telescopic female drug vial adapter for use with a drug vial including a drug vial bottle containing a medicament, and a drug vial rim defining a drug vial opening stopped by a drug vial stopper, the drug vial adapter having a longitudinal drug vial adapter axis and comprising:
(a) a spike component including a transversely directed spike component top wall having
i) a downward depending puncturing member with a puncturing tip for puncturing the drug vial stopper and an opposite upright female connector in flow communication with said puncturing member, and
ii) at least two spaced apart downward depending spike component legs lateral to said puncturing member, said at least two spike component legs terminating at leg tips inwardly protruding toward said puncturing tip; and
(b) a skirt component including a transversely directed skirt component top wall having a central aperture, a downward depending substantially cylindrical skirt of a multitude of drug vial flex members and a skirt component margin remote from said skirt component top wall,
said multitude of drug vial flex members defining a drug vial rim cavity for snugly receiving the drug vial rim therein, said at least two drug vial flex members having leg tip apertures for initially receiving said leg tips in a set-up position of the telescopic female drug vial adapter for initially spacing said spike component top wall from said skirt component top wall with said puncturing member protruding through said central aperture,
the arrangement being such that on urging the drug vial adapter towards a drug vial positioned below said drug vial adapter and manual sliding displacement of said spike component towards said skirt component for stopping thereagainst in an actuated position of the telescopic female drug vial adapter, said drug vial flex members snugly receive the drug vial rim in said drug vial rim cavity, said puncturing member punctures the drug vial stopper and said leg tips are urged radial outward from their corresponding leg tip apertures to slide downward along their corresponding drug vial flex members towards said skirt component margin.

7. The adapter according to claim 6 further comprising a securing arrangement for securing said spike component on said skirt component in said actuated position.

8. The adapter according to claim 7 wherein said spike component includes a pair of opposite spike component legs and said securing arrangement includes a pair of opposite snap fit clips orthogonal to said pair of opposite spike component legs.

9. The adapter according to claim 6 wherein said puncturing member protrudes beyond said skirt component margin in said actuated position.

10. The adapter according to claim 6 wherein said spike component is vented, said spike component top wall includes a circular air filter and at least one vent aperture, and said puncturing member includes a liquid transfer lumen in flow communication with said opposite upright female connector and a venting lumen in flow communication with said air filter, and said venting lumen includes a venting lumen aperture adjacent said puncturing member tip.
